(19) United States
(12) Patent Application Publication
(10) Pub. No.: US 2008/0087363 A1
(43) Pub. Date: Apr. 17, 2008

(54) Pneumatic Tire

(75) Inventor: Masashi Wakatsuki, Kanagawa (JP)

Correspondence Address: GREER, BURNS & CRAIN, 300 S WACKER DR, 25TH FLOOR, CHICAGO, IL, 60606, US

(73) Assignee: YOKOHAMA RUBBER CO., LTD., Tokyo (JP)

(21) Appl. No.: 11/791,249

(22) PCT Filed: Dec. 28, 2005
(86) PCT No.: PCT/JP05/24069

§ 371 Date: May 21, 2007

(30) Foreign Application Priority Data
Jan. 7, 2005 (JP) 2005-002642

(51) Int. Cl. B60C 15/06

(52) U.S. Cl. 152/541

(57) ABSTRACT

Disclosed is a pneumatic tire capable of enhancing durability and reducing rolling resistance while maintaining lateral stiffness. The pneumatic tire of the present invention is provided with at least one carcass ply laid therein so as to extend between a pair of bead portions and formed of organic fiber cords. The tire has a casing structure where a bead filler is arranged to an outer periphery of a bead core buried in the bead portion. Additionally, an air pressure corresponding to the maximum load capacity of the tire is in a range from 350 to 650 kPa. The pneumatic tire is characterized in that the bead filler includes a plurality of rubber layers stacked in a radial direction of the tire, and a cross-sectional area S₁, a hardness Hs₁, and a loss tangent tan δ₁ of the rubber layer on the outermost peripheral side; a cross-sectional area S₂, a hardness Hs₂, and a loss tangent tan δ₂ of the rubber layer on the innermost peripheral side; and a ratio of a bead filler height BFH to a tire cross-sectional height SH are set to have the following relations (1) to (5):
(S₁×tan δ₁)/[(S₁×tan δ₁)+(S₂×tan δ₂)]=0.25 to 0.40, (1)
(S₁×Hs₁)/[(S₁×Hs₁)+(S₂×Hs₂)]=0.35 to 0.50, (2)
BFH/SH=0.25 to 0.60, (3)
Hs₂−Hs₁=10 to 25, and (4)
tan δ₁≦0.1 and tan δ₂−tan δ₁≦0.1 (5).

### TECHNICAL FIELD

The present invention relates to a pneumatic tire suitable for a light truck and provided with a carcass ply formed of organic fiber cords. More specifically, the present invention relates to a pneumatic tire capable of enhancing durability and reducing rolling resistance while maintaining lateral stiffness.

### BACKGROUND ART

As a pneumatic radial tire for a light truck, there is one including a carcass ply formed of organic fiber cords (for example, refer to Patent Document 1). While a pneumatic radial tire of this kind is used with a high air pressure and under a heavy loaded condition, the tire is required to be further improved in durability thereof since a separation failure in a belt edge portion thereof tends to occur in the last stage of abrasion. Additionally, in the pneumatic radial tire of this kind, it is required that rolling resistance be reduced while maintaining lateral stiffness thereof which influences driving stability.

Patent Document 1: Japanese unexamined patent application publication No. Hei6-24206

### DISCLOSURE OF THE INVENTION

An object of this invention is to provide a pneumatic tire capable of enhancing durability and reducing rolling resistance while maintaining lateral stiffness.

The pneumatic tire for achieving the above object is a pneumatic tire: in which at least one carcass ply laid therein so as to extend between a pair of bead portions is formed of organic fiber cords; which has a casing structure where a bead filler is arranged on an outer periphery of a bead core buried in each of the bead portions; and whose air pressure corresponding to the maximum load capacity thereof is in a range from 350 to 650 kPa. The pneumatic tire is characterized in that the bead filler includes a plurality of rubber layers stacked in a radial direction of the tire, and a cross-sectional area S₁, a hardness Hs₁, and a loss tangent tan δ₁ of the rubber layer on the outermost peripheral side; a cross-sectional area S₂, a hardness Hs₂, a loss tangent tan δ₂ of the rubber layer on the innermost peripheral side; and a ratio of a height BFH of the bead filler to a cross-sectional height SH of the tire are set to have relations expressed by
(S₁×tan δ₁)/[(S₁×tan δ₁)+(S₂×tan δ₂)]=0.25 to 0.40, (1)
(S₁×Hs₁)/[(S₁×Hs₁)+(S₂×Hs₂)]=0.35 to 0.50, (2)
BFH/SH=0.25 to 0.60, (3)
Hs₂−Hs₁=10 to 25, and (4)
tan δ₁≦0.1 and tan δ₂−tan δ₁≦0.1. (5)

As a result of having devotedly conducted a research on a pneumatic tire which is provided with a carcass ply formed of organic fiber cords and is used with a high internal pressure, the inventor of the present invention gained knowledge that: the pneumatic tire of this kind causes creep deformation in the carcass ply as a result of running and increases distortion in a belt edge portion, resulting in more likeliness of a separation failure in the belt edge portion in the last stage of abrasion. This knowledge has led the inventor to the present invention.

More specifically, in the present invention, by softening an apex portion of the bead filler based on configurations realized by (2) and (4), the lateral stiffness is maintained while distortion in the belt edge portion being reduced. At the same time, by ensuring the height of the bead filler based on a configuration realized by (3), the creep deformation in the carcass ply is suppressed. With these configurations, it becomes possible to enhance durability of the pneumatic tire which is provided with the carcass ply formed of organic fiber cords and is used with a high internal pressure. Additionally, by reducing heat generation of the apex portion of the bead filler based on configurations realized by (1) and (5), it becomes also possible to reduce rolling resistance thereof.

In the present invention, the bead filler includes a plurality of rubber layers stacked in a radial direction of the tire. In this case, as the above rubber layers, in addition to the outermost and innermost peripheral rubber layers, at least one intermediate rubber layer may be interposed therebetween. For example, the bead filler can be formed of three different rubber layers. However, since excessive presence of the intermediate rubber layer reduces significance of defining physical properties of the outermost and innermost peripheral rubber layers, it is better that a proportion of a cross-sectional area of the intermediate rubber layer with respect to a cross-sectional area of the whole bead filler be 20% or less. As the most preferable configuration, the bead filler includes two different rubber layers stacked in a radial direction of the tire.

Additionally, it is preferred that: the number of the carcass plies be any one of one-layered structure and two-layered structure; all carcass plies be formed as a ply-lock structure where all of the carcass plies are turned up around the bead core from the inside of the tire to the outside; and the highest turned-up edge of the carcass plies be arranged more inwardly in the tire radial direction than the apex of the bead filler. The ply-lock structure here is intended to optimize stiffness of the bead portions and the sidewall portions of the pneumatic tire of the present invention. In particular, it is better that, in the tire radial direction, a distance between the highest turned-up edge of the carcass plies and the apex of the bead filler be at least 15 mm.

In the present invention, the cross-sectional areas S₁ and S₂ of the rubber layers are cross-sectional areas (mm²) measured in a tire cross section taken along a meridian thereof. Additionally, the hardnesses Hs₁ and Hs₂ are JIS-A hardnesses measured at a temperature of 25° C., for example, by attaching a JIS-A hardness meter perpendicularly to a cut sample of the bead filler. Furthermore, loss tangents tan δ₁ and tan δ₂ are each measured by having a rubber specimen of 40 mm×5 mm×2 mm mounted onto a dynamic viscoelasticity measuring device in order that the specimen can be distorted in a longitudinal direction, and then by providing an initial distortion of 10% under a temperature of 60° C. with conditions being an amplitude of ±2%, and a frequency of 20 Hz.

Note that an air pressure corresponding to the maximum load capacity is one defined by a certain standard, that is, for example, an air pressure specified in the correspondence table of air pressures and load capacities in the JATMA YEAR BOOK (the year 2004 edition).

### BRIEF DESCRIPTION OF DRAWINGS

FIG. 1 is a half cross-sectional view showing a small truck pneumatic radial tire configured of an embodiment of the present invention, the view being taken along a meridian of the tire.

### BEST MODE FOR CARRYING OUT THE INVENTION

Hereinbelow, a configuration of the present invention will be described in detail with reference to the accompanying drawing.

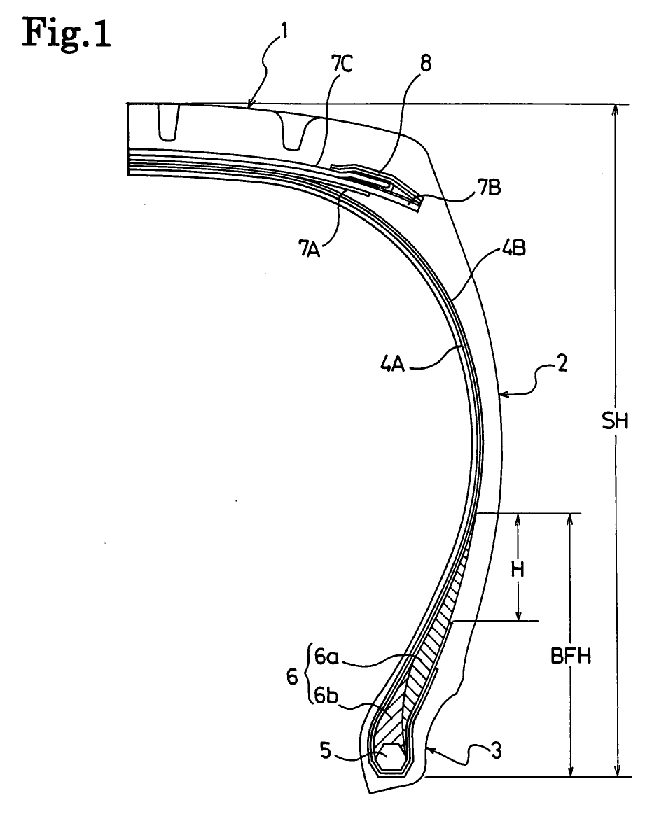

FIG. 1 shows a light truck pneumatic radial tire configured of an embodiment of the present invention. In FIG. 1, reference numerals 1, 2 and 3 denote a tread portion, a sidewall portion, and a bead portion, respectively. Two carcass plies 4A and 4B are laid therein so as to extend between a pair of the bead portions 3, 3. The respective carcass plies 4A and 4B are formed of pluralities of organic fiber cords, each of which is oriented in a radial direction of the tire. As the organic fiber cords, nylon cords, polyester cords and the like can be used. The carcass plies 4A and 4B are turned up from the inside of the tire to the outside in a manner that the carcass plies wrap up a bead core 5 and a bead filler 6 which are buried in the bead portion 3.

On the other hand, in an outer periphery of the carcass plies 4A and 4B in the tread portion 1, three belt layers 7A, 7B and 7C are buried along an entire circumference of the tire. Each of these belt layers 7A to 7C includes a plurality of reinforcement cords inclined with respect to a circumferential direction of the tire. The belt layers 7A to 7C are arranged in a manner that the reinforcement cords are crossed over each other in the layers. Additionally, in the vicinity of an edge portion of the belt layers 7A to 7C, a belt cover layer 8, which is formed by winding up organic fiber cords at an angle tilted substantially by 0 degrees with respect to the tire circumferential direction, is provided.

In the abovementioned pneumatic radial tire, the respective carcass plies 4A and 4B are formed of organic fiber cords, and the three belt layers 7A to 7C are arranged on an outer periphery of the carcass plies 4A and 4B. At the same time, the tire has a casing structure where the bead filler 6 is arranged on the outer periphery of the bead core 5. Moreover, a pneumatic pressure corresponding to the maximum load capacity of the tire is specified to be in a range from 350 to 650 kPa.

In the abovementioned pneumatic radial tire, the bead filler 6 is formed of two different rubber layers 6a and 6b stacked in the tire radial direction. Those rubber layers 6a and 6b are laminated in the tire radial direction, and however, cross-sectional shapes thereof are not particularly limited. Here, a cross-sectional area S₁, a hardness Hs₁, a loss tangent tan δ₁ of the rubber layer 6a on the outermost peripheral side; a cross-sectional area S₂, a hardness Hs₂, a loss tangent tan δ₂ of the rubber layer 6b on the innermost peripheral side; and a ratio of a height BFH of the bead filler to a cross-sectional height SH of the tire are set to have the following relations (1) to (5). Note that both the tire cross-sectional height SH and bead filler height BFH are heights from a bead heel of the tire in the tire radial direction:
(S₁×tan δ₁)/[(S₁×tan δ₁)+(S₂×tan δ₂)]=0.25 to 0.40, (1)
(S₁×Hs₁)/[(S₁×Hs₁)+(S₂×Hs₂)]=0.35 to 0.50, (2)
BFH/SH=0.25 to 0.60, (3)
Hs₂−Hs₁=10 to 25, and (4)
tan δ₁≦0.1 and tan δ₂−tan δ₁≦0.1. (5)

By softening an apex portion of the bead filler 6 based on configurations realized by (2) and (4) as described above, the lateral stiffness is maintained while distortion in the belt edge portion being reduced. At the same time, by ensuring the height of the bead filler 6 based on a configuration realized by (3), the creep deformation in the carcass plies is suppressed. With these configurations, it is possible to enhance durability of the light truck pneumatic radial tire which is provided with the carcass plies 4A and 4B formed of organic fiber cords and is used with a high internal pressure. Additionally, by reducing an amount of heat generation of the apex portion of the bead filler 6 based on configurations realized by (1) and (5), it is also possible to reduce the rolling resistance thereof.

Regarding the configuration realized by (1) with conditions (2) to (5) satisfied, if a value of (S₁×tan δ₁)/[(S₁×tan δ₁)+(S₂×tan δ₂)] becomes smaller than 0.25, the rolling resistance is increased, and if the value exceeds 0.40 to the contrary, the lateral stiffness cannot be maintained. A more preferable range of (S₁×tan δ₁)/[(S₁×tan δ₁)+(S₂×tan δ₂)] is from 0.30 to 0.35.

Regarding the configuration realized by (2) with conditions (1) and (3) to (5) satisfied, if a value of (S₁×Hs₁)/[(S₁×Hs₁)+(S₂×Hs₂)] becomes smaller than 0.35, the lateral stiffness cannot be maintained, and if the value exceeds 0.50 to the contrary, a reduction effect on distortion in the belt edge portion will be insufficient. A more preferable range of (S₁×Hs₁)/[(S₁×Hs₁)+(S₂×Hs₂)] is from 0.40 to 0.45.

Regarding the configuration realized by (3), if a value of BFH/SH is smaller than 0.25, the lateral stiffness is reduced while an effect of suppressing the creep deformation in the carcass plies being insufficient, and if the value exceeds 0.60 to the contrary, the reduction effect on distortion in the belt edge portion becomes insufficient. A preferable range of BFH/SH is from 0.35 to 0.45.

Regarding the configuration realized by (4), if a value of Hs₂−Hs₁ is smaller than 10, an effect of reducing distortion in the belt edge portion while maintaining the lateral stiffness will be insufficient. Contrary to this, if the value exceeds 25, a stiffness difference between the rubber layers constituting the bead filler becomes excessive, resulting in insufficiency of durability of the tire in a rim cushion portion.

Regarding the configuration realized by (5), if a value of tan δ₁ exceeds 0.1, the rolling resistance is increased. On the other hand, if a value of tan δ₂−tan δ₁ exceeds 0.1, a difference of a heat generation between the rubber layers forming the bead filler becomes excessive, resulting in insufficiency of durability of the tire in the rim cushion portion.

In the abovementioned pneumatic radial tire, the two carcass plies 4A and 4B are turned up around the bead core 5 from the inside of the tire to the outside, and the highest turned-up edge of the carcass plies 4A and 4B is arranged more inwardly in the tire radial direction than the apex of the bead filler 6. A ply-lock structure as described here prevents stiffness of a vicinity of the apex of the bead filler 6 from being excessively increased, whereby it becomes possible to obtain a reduction effect on distortion in the belt edge portion. In particular, it is better that a distance H between the highest turned-up edge of the carcass plies 4A and 4B and the apex of the bead filler 6 be at least 15 mm in the tire radial direction.

Although the pneumatic tire provided with the two carcass plies formed of organic fiber cords has been described in the above embodiment, the present invention can be applied to a pneumatic tire provided with only one carcass ply formed of organic fiber cords. In this case as well, it is preferred that the one carcass ply be turned up around a bead core from the inside of the tire to the outside, and that a turned-up edge of the carcass ply be arranged more inwardly in the tire radial direction than an apex of a bead filler.

The preferred embodiment of the present invention has been described hereinabove. However, it should be understood that various modifications to, substitutions for, and replacements with the preferred embodiment can be carried out as long as the modifications, the substitutions, and the replacements do not depart from the spirit and the scope of the present invention defined by the attached claims.

### EXAMPLES

Tires of Examples 1 and 2 and Comparative Examples 1 to 6 were prepared as follows. In pneumatic radial tires for a light truck each of which a tire size is 195/75R15 and an air pressure corresponding to the maximum load capacity thereof is 600 kPa, a bead filler of each of the tires includes two different rubber layers stacked in a radial direction of the tire. In each of the pneumatic tires, a cross-sectional area S₁, a hardness Hs₁, a loss tangent tan δ₁ of the rubber layer on the outermost side, and a cross-sectional area S₂, a hardness Hs₂, a loss tangent tan δ₂ of the rubber layer on the innermost peripheral side, and a ratio of a height BFH of the bead filler to a cross-sectional height SH of the tire were set variously different from those in the other ones of the pneumatic tires. Additionally, for the purpose of comparison, a pneumatic radial tire for a light truck (Prior Art) was prepared, the pneumatic radial tire being provided with a bead filler constituted of one rubber layer.

For theses test tires, rolling resistance, driving stability and durability were assessed by the following test methods, respectively, and results of the assessment are shown in Table 1 as follows.

Rolling Resistance:

Each of the test tires was assembled onto an wheel of a rim size of 15×5·½ J, and by using an indoor drum-testing machine, rolling resistance thereof was measured when each of the test tire was allowed to run under conditions that an air pressure is 600 kPa, a load is 10.1 kN, and a speed is 80 km/h. Results of the assessment are shown in index numbers obtained by taking a rolling resistance value of Prior Art as 100. The lower value of the index number is, the smaller rolling resistance is.

Driving Stability:

Each of the test tires was assembled onto an wheel of a rim size of 15×5·½ J, installed to a light truck having a gross vehicle weight of 5 tons, and inflated at an air pressure of 600 kPa. Then, a feeling test by test drivers was performed on the tire. Results of the assessment are shown in index numbers obtained by taking a value of Prior Art as 100. The higher value of the index number is, the better driving stability (an indicator of the optimum level of lateral stiffness) is.

Durability:

By using a drum-testing machine having a drum diameter of 1707 mm, a durability test specified by JIS D-4230 was performed on each of the test tires, and was followed by measurement of a mileage traveled until a failure occurs in any one of a belt edge portion and a rim cushion portion thereof. The measurement was conducted under the condition that, every 6 hours, a load on the tire was increased by 8% of the standard maximum load thereof and a speed was increased by 5%. Results of the assessment are shown in index numbers obtained by taking a value of Prior Art as 100. The higher value of the index number is, the better durability is.

As is evident from Table 1, in comparison with the tire of Prior Art, the tires of Examples 1 and 2 were able to be lower in rolling resistance with the driving stability being maintained, and at the same time, were excellent in the durability. On the other hand, because the tires of Comparative Examples 1 to 6 were out of the scope defined by the present invention, none of them was able to simultaneously satisfy the durability, driving stability and rolling resistance. In particular, while the tires of Comparative Examples 1 to 4 each had a failure in the belt edge portion in the durability test, the tires of Comparative Examples 5 and 6 each had a failure in the rim cushion portion because they each had an excessive difference in physical properties between the two rubber layers constituting the bead filler.

TABLE 1

| | | | | | Loss | Loss | (S₁ × tanδ₁)/ |
|---|---|---|---|---|---|---|---|
| | Hardness | Hardness | Cross-sectional | Cross-sectional | tangent | tangent | [(S₁ × tanδ₁) + |
| | Hs₁ | Hs₂ | area S₁ (mm²) | area S₂ (mm²) | tanδ₁ | tanδ₂ | (S₂ × tanδ₂)] |
| Prior Art | — | (80) | — | (2) | — | (0.13) | — |
| Example 1 | 58 | 80 | 1 | 1.27 | 0.06 | 0.13 | 0.27 |
| Example 2 | 58 | 80 | 1.38 | 1 | 0.06 | 0.13 | 0.39 |
| Comparative | 58 | 80 | 1 | 1.6 | 0.06 | 0.13 | 0.22 |
| Example 1 | | | | | | | |
| Comparative | 58 | 80 | 1.6 | 1 | 0.06 | 0.13 | 0.42 |
| Example 2 | | | | | | | |
| Comparative | 58 | 80 | 1.8 | 1 | 0.06 | 0.13 | 0.45 |
| Example 3 | | | | | | | |
| Comparative | 58 | 80 | 1 | 1.27 | 0.06 | 0.13 | 0.27 |
| Example 4 | | | | | | | |
| Comparative | 50 | 80 | 1 | 1.27 | 0.06 | 0.13 | 0.27 |
| Example 5 | | | | | | | |
| Comparative | 58 | 80 | 1 | 1.27 | 0.04 | 0.15 | 0.17 |
| Example 6 | | | | | | | |

| | (S₁ × Hs₁)/ | | | | | | |
|---|---|---|---|---|---|---|---|
| | [(S₁ × Hs₁) + | | | | Rolling | Driving | |
| | (S₂ × Hs₂)] | BFH/SH | Hs₂ − Hs₁ | tanδ₂ − tanδ₁ | resistance | stability | Durability |
| Prior Art | — | 0.50 | — | — | 100 | 100 | 100 |
| Example 1 | 0.36 | 0.50 | 22 | 0.07 | 97 | 100 | 115 |
| Example 2 | 0.50 | 0.50 | 22 | 0.07 | 96 | 100 | 120 |
| Comparative | 0.31 | 0.50 | 22 | 0.07 | 101 | 95 | 99 |
| Example 1 | | | | | | | |
| Comparative | 0.54 | 0.50 | 22 | 0.07 | 98 | 95 | 110 |
| Example 2 | | | | | | | |
| Comparative | 0.57 | 0.50 | 22 | 0.07 | 99 | 96 | 108 |
| Example 3 | | | | | | | |
| Comparative | 0.36 | 0.65 | 22 | 0.07 | 97 | 100 | 98 |
| Example 4 | | | | | | | |
| Comparative | 0.33 | 0.50 | 30 | 0.07 | 97 | 95 | 98 |
| Example 5 | | | | | | | |
| Comparative | 0.36 | 0.50 | 22 | 0.11 | 97 | 100 | 98 |
| Example 6 | | | | | | | |

What is claimed is:

1. A pneumatic tire, in which at least one carcass ply laid therein so as to extend between a pair of bead portions is formed of organic fiber cords; which has a casing structure where a bead filler is arranged on an outer peripheral side of a bead core buried in each of the bead portions; and whose air pressure corresponding to the maximum load capacity thereof is in a range from 350 to 650 kPa,
wherein the bead filler includes a plurality of rubber layers stacked in a radial direction of the tire, and a cross-sectional area S₁, a hardness Hs₁, and a loss tangent tan δ₁ of the rubber layer on the outermost peripheral side; a cross-sectional area S₂, a hardness Hs₂, and a loss tangent tan δ₂ of the rubber layer on the innermost peripheral side; and a ratio of a height BFH of the bead filler to a cross-sectional height SH of the tire are set to have relations expressed by
(S₁×tan δ₁)/[(S₁×tan δ₁)+(S₂×tan δ₂)]=0.25 to 0.40, (1)
(S₁×Hs₁)/[(S₁×Hs₁)+(S₂×Hs₂)]=0.35 to 0.50, (2)
BFH/SH=0.25 to 0.60, (3)
Hs₂−Hs₁=10 to 25, and (4)
tan δ₁≦0.1 and tan δ₂−tan δ₁≦0.1. (5)

2. The pneumatic tire according to claim 1, wherein the bead filler includes two different rubber layers stacked in a radial direction of the tire.

3. The pneumatic tire according to any one of claims 1 and 2, wherein:
the number of the carcass plies is any one of one-layered structure and two-layered structure;
all of the carcass plies are turned up around the bead core from the inside of the tire to the outside; and
the highest turned-up edge of the carcass plies is arranged more inwardly than an apex of the bead filler in a radial direction of the tire.

4. The pneumatic tire according to claim 3, wherein a distance between the highest turned-up edge of the carcass plies and the apex of the bead filler in the radial direction of the tire is set to be at least 15 mm.
